(19) United States
(12) Patent Application Publication
(10) Pub. No.: US 2014/0379477 A1
(43) Pub. Date: Dec. 25, 2014

(54) SYSTEM AND METHOD FOR CROWD BASED CONTENT DELIVERY

(71) Applicant: Amobee Inc., Redwood City, CA (US)

(72) Inventors: Gil Mati SHEINFELD, Hod Hasharon, IL (US); Eliyahu Greitzer, Hertzlia, IL (US); Lior Leiba, Haifa, IL (US)

(21) Appl. No.: 13/925,977

(22) Filed: Jun. 25, 2013

(51) Int. Cl. G06Q 30/02

(52) U.S. Cl. CPC G06Q 30/0251
USPC 705/14.58; 705/14.49

(57) ABSTRACT

A system and method for crowd based content delivery. A crowd of users may be associated with an electronic billboard. A profile may be generated for the crowd. A digital content item may be selected based on the crowd profile. The digital content item may be presented by the electronic billboard. Other embodiments are described and claimed.

### FIELD OF THE INVENTION

The present invention is in the field of digital or electronic billboards, more particularly, to selecting and presenting content on digital or electronic billboards.

### BACKGROUND OF THE INVENTION

Digital or electronic billboards or other displays are widely used for presenting and/or publishing content. For example, digital billboards are placed in shopping malls and by roads. Currently, content presented on electronic billboards is selected based on various considerations, e.g., the geographic location of the billboard, time of day and the like.

However, current systems and methods for selecting content for presentation on electronic billboards suffer from a number of disadvantages. For example, content for presentation on a billboard is selected regardless of attributes of the viewers or viewing crowd (e.g., a group of people) around the billboard.

### SUMMARY OF EMBODIMENTS OF THE INVENTION

A system and method for crowd or viewer group based content delivery may include associating a crowd of target users with an electronic billboard or other display; generating a crowd profile or description for the crowd; selecting a digital content item based on the crowd profile, and presenting the selected digital content on the electronic billboard. A method may include dynamically updating the crowd profile based on proximity of a plurality of users (e.g., people viewing, or likely to view, or possibly able to view, the billboard; other parameters may be used to describe users or crowd members, such as mere proximity to the billboard) to the electronic billboard. A system according to embodiments of the invention may associate a crowd of target users with an electronic billboard, generate a crowd profile for the crowd, select a digital content item based on the crowd profile, and present the selected digital content on the electronic billboard.

In an embodiment, the electronic billboard is mobile and the crowd profile is updated based on a location of the electronic billboard. A method may comprise including a user in a crowd of target users based on at least one of: a direction of movement, a speed of movement, an origin of a trip and a destination of a trip. A method may include selecting a digital content item for presentation on the billboard based on an attribute of the crowd of target users.

A system and method may include generating the crowd profile based on at least one of: an age, a gender and a socioeconomic status parameter of a majority or plurality of the target users. In an embodiment, generating the crowd profile includes calculating a probability value related to an attribute of a user included in the crowd and updating the crowd profile based on the probability value. A method may include associating a plurality of content items with a respective plurality of scores based on the crowd profile and selecting for presentation one of the content items based on an associated score. A method may include selecting digital content for presentation on a billboard based on an interaction of a user with a mobile communication device. A method may include generating the crowd profile based on a plurality of profiles of a respective plurality of users included in the crowd.

A system and method may include, for a crowd of users associated with a display, generating a description based on characteristics of the users; and displaying a content item based on the description. A system and method may include updating a description of a crowd based on a proximity of a plurality of users a display.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features and advantages thereof, may best be understood by reference to the following detailed description when read with the accompanied drawings. Embodiments of the invention are illustrated by way of example and not limitation in the figures of the accompanying drawings, in which like reference numerals indicate corresponding, analogous or similar elements, and in which:

FIG. 1 is a high level block diagram of a system according to embodiments of the present invention;

FIG. 2 shows a flowchart diagram and related components according to some embodiments of the present invention;

FIG. 3 shows a flowchart diagram illustrating a method for group or crowd based content delivery according to some embodiments of the present invention; and

FIG. 4 shows high level block diagram of an exemplary computing device according to embodiments of the present invention.

It will be appreciated that for simplicity and clarity of illustration, elements shown in the figures have not necessarily been drawn accurately or to scale. For example, the dimensions of some of the elements may be exaggerated relative to other elements for clarity, or several physical components may be included in one functional block or element. Further, where considered appropriate, reference numerals may be repeated among the figures to indicate corresponding or analogous elements.

### DETAILED DESCRIPTION OF EMBODIMENTS OF THE INVENTION

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory processor-readable storage medium that may store instructions, which when executed by the processor, cause the processor to perform operations and/or processes. Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. The term set when used herein may include one or more items. Unless explicitly stated, the method embodiments described herein are not constrained to a particular order or sequence. Additionally, some of the described method embodiments or elements thereof can occur or be performed simultaneously, at the same point in time, or concurrently.

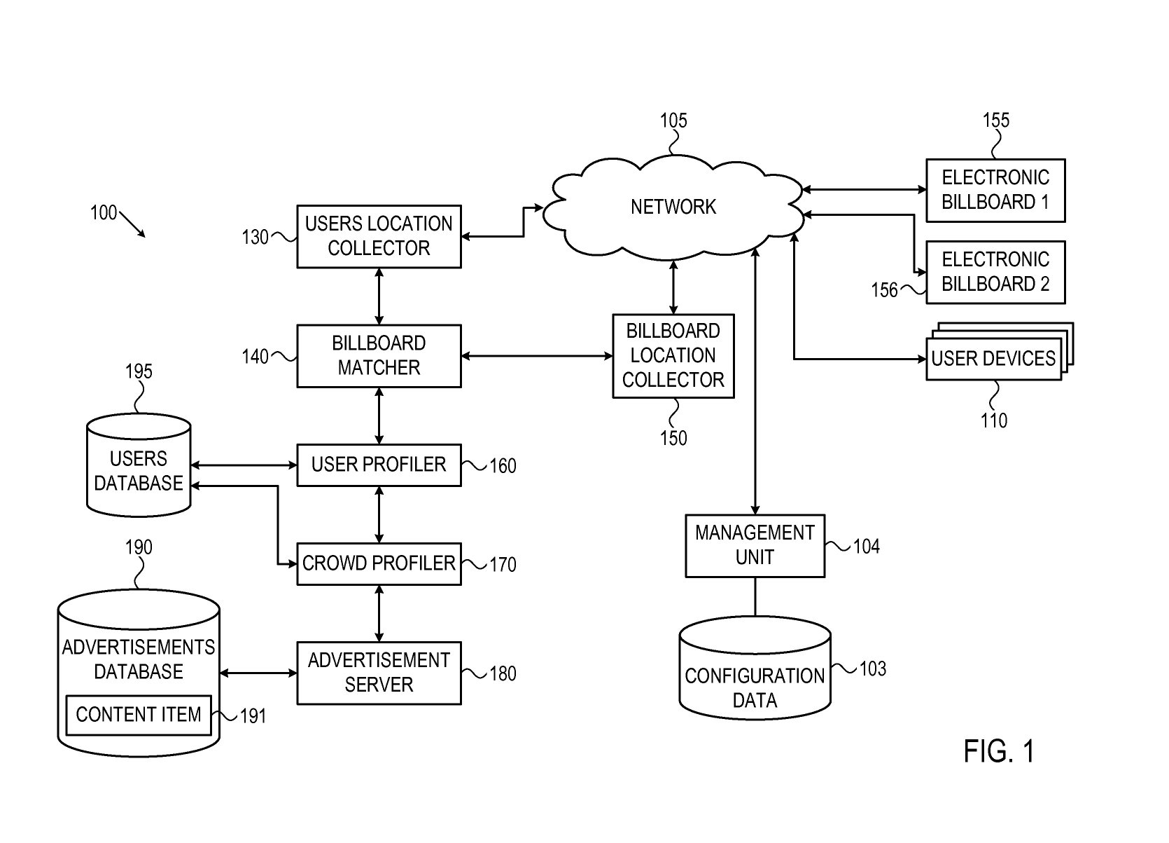

Reference is now made to FIG. 1, a high-level block diagram of a system 100 according to embodiments of the present invention. As shown, system 100 may include a users locations collector (ULC) 130, a billboard matcher 140, a user profiler 160, a billboard locations collector (BLC) 150, a crowd profiler 170, an advertisement server (ad server) 180, a users database (users DB) 195, an advertisement database (ad DB) 190 and displays such as electronic billboards 155 and 156. As shown, ad DB 190 may include content item 191. It will be understood that although a single content item 191 is shown, ad DB 190 may (and typically does) include or store a large number of content items. For example, thousands of content items, e.g., advertisements that may be video clips or images, may be stored in ad DB 190 as shown by content item 191. While shown separately, the various units and devices discussed may be combined into a smaller number of units or devices.

Devices such as ULC 130, billboard matcher 140, user profiler 160, BLC 150 and a crowd profiler 170 may be any suitable unit, module or component. For example, ULC 130, billboard matcher 140, user profiler 160, BLC 150 and a crowd profiler 170 may be or include software modules executed on any suitable computing device.

As shown, system 100 may include, or communicate with, user devices 110. As further shown, system 100 includes a network 105. As further shown, system 100 may include a management unit 104 and configuration data 103. Management unit 104 may be a computing device including a display, keyboard, mouse and the like and may be used by a manager of system 100 to configure, monitor and manage system 100. Configuration data 103 may be or may include rules, criteria or other parameters used by system 100 as described herein.

Electronic billboards 155 and 156 may be stationary or mobile, and may be other displays, such as an information terminal, a computer monitor, etc. Electronic billboards 155 and 156 may be any suitable digital or electronic billboards as known in the art, e.g., include light emitting diodes (LED) components, plasma displays and the like. Electronic billboard 155 may be stationary, e.g., located near a road or in a shopping mall as known in the art and electronic billboard 156 may be mobile, e.g., mounted on a bus or train. For the sake of clarity, only two electronic billboards are shown in FIG. 1, however, it will be understood that a large number of mobile and/or stationary electronic billboards similar to electronic billboards 155 and 156 may be included in a system according to embodiments of the invention.

In an embodiment, electronic billboards 155 and 156 include a component, card or module designed to communicate over network 105. In an embodiment, electronic billboards 155 and 156 include a unit, component, card or module capable of storing and providing an identification parameter. For example, in an embodiment, electronic billboards 155 and 156 include a subscriber identity module (or subscriber identification module (SIM)) as known in the art. Accordingly, each electronic billboard included in system 100 may be uniquely identified, e.g., as mobile telephones are identified by systems known in the art. In another embodiment, e.g., when an electronic billboard is stationary, a billboard may be connected to network 105 over an internet protocol (IP) network and an IP address may be used to identify the billboard and/or determine its location.

In an embodiment, a unit, chip or card included in billboards 155 and 156 calculates or determines the location of the respective billboard and transmits location information, e.g., to billboard location collector 150. Accordingly, system 100 may determine a location of an electronic billboard. For example, in an embodiment, electronic billboards 155 and 156 include a global positioning system (GPS) unit as known in the art and a transmit/receive unit designed to transmit location information over network 105. In an embodiment, components enabling a smartphone or mobile phone to determine and transmit location information as known in the art are included in electronic billboards 155 and 156. For example, in an embodiment, billboards 155 and 156 include a GPS unit, a SIM storing an international mobile subscriber identity (IMSI) or key and a receiver/transmitter unit enabling billboards 155 and 156 to communicate location and identification data over network 105. Other methods of locating billboards or displays may be used, e.g. a pre-configured parameter.

User devices 110 may be a mobile telephone or smartphone as known in the art. In other embodiments, users devices 110 may be a laptop or mobile computer. In yet other embodiments, user devices 110 may be a home computer. In an embodiment, user devices 110 include a SIM and a GPS unit. Accordingly, an identity and location of each one of user devices 110 may be provided to system 100, e.g., to user location collector 130. Other methods of location detection of user devices may be used.

For example, as known in the art, an identity of a user (or user's device) and a location of the user (or the user's device) are known to a company that provides voice or data services. For example, carriers such as T-Mobile and Verizon possess identification and location information based on information stored on a user's SIM card and based on data provided by a GPS unit included in the user's device. In an embodiment, a carrier shares identity and location information with system 100. Other systems and methods may be used in order to obtain user location and identification data. For example, a user login name and an IP address may be used in order to determine a location and identity of a user in a home or an internet café. In yet another embodiment, signal triangulation techniques known in the art are used to determine a location of a user device. It will be understood that the scope of the invention is not limited by the system or method used to determine and/or obtain an identity and location of users that operate user devices 110.

Network 105 may be any suitable network enabling components of system 100 to communicate. In an embodiment, at least part of network 105 may be operated by a carrier as known in the art. Network 105 may be, may comprise or may be part of a private or public IP network, or the internet, or a combination thereof. Network 105 may be, comprise or be part of a global system for mobile communications (GSM) network. For example, network 105 may include or comprise an IP network such as the internet, a GSM related network and any equipment for bridging or otherwise connecting such networks as known in the art. In addition, network 105 may be, may comprise or be part of a public or private data network, a local area network (LAN), a wireline or wireless network, a global communication network, a satellite communication network, a cellular communication network, any combination of the preceding and/or any other suitable communication means. Accordingly, numerous elements of network 105 are implied but not shown, e.g., access points, base stations, communication satellites, GPS satellites, routers, telephone switches, etc. It will be recognized that embodiments of the invention are not limited by the nature of network 105.

Billboards location collector 150 collects billboards' locations. For example, billboards location collector 150 receives from a carrier GPS data related to electronic billboards 155 and 156. In another embodiment, billboards location collector 150 receives IP addresses of electronic billboards 155 and 156 and deduces the location of electronic billboards 155 and 156 based on their IP addresses. For example, a table or list that includes a location of billboards and their IP addresses may be used by location collector 150 in order to determine a location of a billboard based on the associated IP address. Other parameters identifying a billboard may be used. In an embodiment, location collector 150 is provided with a location of a billboard, e.g., a user provides location collector 150 with an identification parameter and a location of a billboard.

Any other location information obtained or calculated for electronic billboards 155 and 156 as described herein may be collected by billboards location collector 150. For example, billboards location collector 150 receives location information related to electronic billboards 155 and 156 from a carrier or a mobile network operator that operates network 105. As described herein, both an identification and a location of a billboard may be received or obtained by billboards location collector 150. For example, an identification as provided by a SIM installed in a billboard and a location generated by a GPS unit included in the billboard are obtained by an operator of network 105 and provided to billboards location collector 150. Location information related to billboards 155 and 156 may be continuously updated, e.g., as billboards 155 and 156 change location when installed on a vehicle. For example, billboards location collector 150 may periodically probe a network operator to receive location information related to billboards 155 and 156. Accordingly, in an embodiment, system 100 tracks billboards 155 and 156 as they move and content presented by billboards 155 and 156 may be dynamically and/or automatically selected based on their location.

Users location collector 130 collects users' locations (or the locations of users devices). For example, users location collector 130 receives from a carrier GPS data related to user devices 110. In another embodiment, users location collector 130 receives IP addresses of user devices 110 and deduces the location of user devices 110 based on their IP addresses. For example, IP addresses may be allocated by an internet service provider (ISP) according to a location, accordingly, using an IP address a location may be determined. Any other location information obtained or calculated for user devices 110 as described herein may be collected by users location collector 130. For example, users location collector 130 receives location information related to user devices 110 from a carrier or a mobile network operator that operates network 105.

Billboard matcher 140 may match or associate users, or members of crowds or groups, with billboards or displays. In an embodiment, billboard matcher 140 defines a crowd or groups by generating a list of users or members and associating the list with a specific billboard. Users may be identified by or associated with the devices operated by the users (user devices 110) and when used herein users may be operatively synonymous with user devices. A group or crowd may be defined by associating a set, plurality or group of users with a billboard or display using any suitable operations. In one embodiment and as shown, billboard matcher 140 receives users' locations from users location collector 130 and billboards' locations from billboards location collector 150 and uses received information to match or associate users with billboards. For example, billboard matcher 140 associates or matches users with a billboard if their distance from the billboard is less than a predefined value, e.g., less than 500 yards. A crowd need not be a contiguous group of people; when used herein a crowd or group may be a certain set of people interspersed with other people, not in the crowd.

A distance of a user from a billboard may be one example of a criteria used for matching the user with the billboard, other criteria may be used. For example, a direction of movement (e.g., calculated based on GPS data obtained as described herein) may be another criteria used for associating a user with a billboard. For example, a billboard may be placed on the side of a road facing drivers travelling south. In some cases, passengers and drivers heading north on the same road may not be able to see the content presented on the billboard. In such case, billboard matcher 140 may only associate with the billboard users going south and may further avoid associating with the billboard users driving north on the same road, even though the users going north are close to the billboard.

In an embodiment, using management unit 104, an operator may define one or more rules to be used by billboard matcher 140. A rule may be defined for a specific billboard or for a group of billboards. For example, a rule may be related to a proximity, e.g., a rule may define a maximal distance of users from a billboard and, only users who are less than the maximal distance from the billboard are associated with the billboard. In another example, a rule may define a direction of movement as a criteria to be used for matching users with a billboard, e.g., in the example above, a rule for a specific billboard may be defined such that only users travelling in a specific direction (e.g., south in the above example) are to be associated with the billboard.

Using management unit 104, a manager or operator of system 100 can configure rules for specific billboards. Rules defined using management unit 104 may be stored in configuration data 103 and may be provided to relevant components in system 100. For example, matching rules are provided, over network 105, from management unit 104 to billboard matcher 140.

In another example, a rule or criteria is related to speed of movement. For example, a rule defined by a manager of system 100 dictates that only users travelling at a speed less than sixty (60) miles per hour are to be associated with a billboard. For example, it may be determined that users passing by a billboard at a speed greater than sixty (60) miles an hour are unlikely to read, see or even notice content displayed on the billboard. In such case, a rule that excludes fast travelling users may be configured thus only users who are likely to be affected by content presented are associated with the billboard.

As described, a rule may be defined for a specific billboard. For example, for a large billboard, a rule excluding users travelling at sixty (60) miles per hour may be defined and, for a smaller billboard, a rule excluding users travelling at thirty (30) miles per hour may be defined.

User profiler 160 may analyze data related to users (e.g., data stored in users DB 195) and may determine parameters that may be used in selecting content to be displayed on a digital billboard. In an embodiment, data related to users is continuously collected and stored in users DB 190. For example, recent locations visited by a user (e.g., determined based on GPS data continuously or otherwise collected) may be recorded, for each user, in users DB 195. A speed of movement (e.g., determined based on GPS data) may be recorded in users DB 195. Other data stored in users DB 195 may be demographic or other information, e.g., age, gender, home address, income and the like.

A user profile may be stored and maintained in users DB 195. Although not shown, various systems (e.g., social networks, search engines or any relevant third party entity) may be interacted with in order to obtain information that may be used in order to generate a profile for a user. For example, demographic information described herein may be obtained from any relevant system or platform or it may be obtained directly from users who may provide an operator of system 100 with details such as age, gender and the like. It will be understood that the scope of the invention is not limited by the systems and methods used for obtaining user information stored in users DB 195 and that any system or method known in the art for collecting user information may be used by system 100 without departing from the scope of the invention.

Generally, using an identification provided by a user device (e.g., by a SIM as described), user profiler 160 may locate a user's profile or record in users DB 195. Accordingly, as users are detected in a vicinity of a billboard, their profile may be retrieved from users DB 195. In an embodiment, content presented by digital billboards 155 and 156 includes advertisements. In order to select an advertisement to be presented by a billboard, profiles of users who are in the proximity of the billboard are examined. Accordingly, content presented on a billboard may be selected based on a attributes of a plurality of users (or a crowd) present in a proximity of the billboard.

In an embodiment, user profiler 160 may analyze data related to real-time aspects of users and a selection of content presented on a billboard may be based on real-time aspects related to a plurality of users, or a crowd that is present near the billboard. For example, user profiler 160 may determine (or receive as described herein) information such as a current velocity or speed with which a user is passing by a billboard, a source and destination of a current trip, recent purchases and the like. Accordingly, profiling a user or crowd may be based on real-time aspects and content presented on a billboard may be selected based on real-time aspects or activities of users near the billboard. Another real-time aspect may be a state of a user's device. For example, a real-time profile or parameter calculated for a user may reflect that the user is currently interacting with her smartphone. For example, provided with network related information from a carrier, user profiler 160 may determine that a user is currently surfing the internet using her mobile phone. As described, such aspects or attributes of a user may be used in order to generate or create a crowd profile or description. Any information or parameter, generated or collected by users profiler 160 may be provided to crowd profiler 170 and may be used in generating a crowd profile. The description or crowd profile may summarize or include characteristics of the members of the crowds.

For example, by determining whether or not a user or crowd member is facing a billboard (e.g., based on a direction of travel) or whether a user rides a car, a bicycle or is walking (e.g., based on speed or movement data received from the user's GPS system) user profiler 160 can profile or classify users and/or a crowd of users and an advertisement may be selected based on the profiling or classification of the users near the billboard. For example, advertisements that require relatively long time to read or comprehend may be avoided if it is determined that users in a crown near a billboard are moving fast and thus may not have time to effectively exposed to content on the billboard, in such case, content that is effective over short periods of exposures (e.g., large graphics as oppose to a detailed description of a product) may be chosen.

User profiler 160 may profile or classify users, or associate users with scores, based on any relevant data. For example, data such as browsing statistics, recent exposure to advertisements, clicking history (e.g., how frequently and on which advertisements the user clicked) may all be examined. For example, data (e.g., browsing or clicking history) may be collected from a user device, analyzed and used to update a user's profile in users database 195.

User profiler 160 may exclude or filter out some users from a crowd of users. For example, even though a user is close to a billboard and, based on the user's location, the user's profile and attributes such as speed and direction of travel, the user would have been associated with the billboard, or included in a crowd associated with the billboard user profiler 160 may exclude the user from the crowd based on one or more parameters. For example, based on demographic information related to the user, if user profiler 160 identifies that a user is below minimal age for targeting, user profiler 160 may exclude a user from a crowd.

User profiler 160 may profile and/or score a user, in real-time. For example, user profiler 160 may determine whether the user is driving or walking near a billboard and associate a score with the user based on location, speed etc. A user currently interacting with a mobile telephone (e.g., as determined based on browsing information provided by a carrier) may be scored higher than a user driving a car. User responsiveness to content presented on a digital billboard may be used in scoring or profiling a user. As described, users' profiles, e.g., real-time profiles and profiles otherwise obtained may be used to generate or create a crowd profile or description, e.g., by crowd profiler 170 as described herein.

Crowd profiler 170 may profile or classify a crowd of users or members of the crowd, or use characteristics of the crowd to generate or create a crowd profile. In an embodiment, crowd profiler 170 receives information related to a plurality of users from user profiler 160. As described, billboard matcher 140 may define a crowd by associating a set, plurality or group of users with a billboard using any means. A definition of a crowd, (e.g., a list of users and an identification of a billboard) may be provided to user profiler 160 and to crowd profiler 170. For example, a pointer to a memory location may be used.

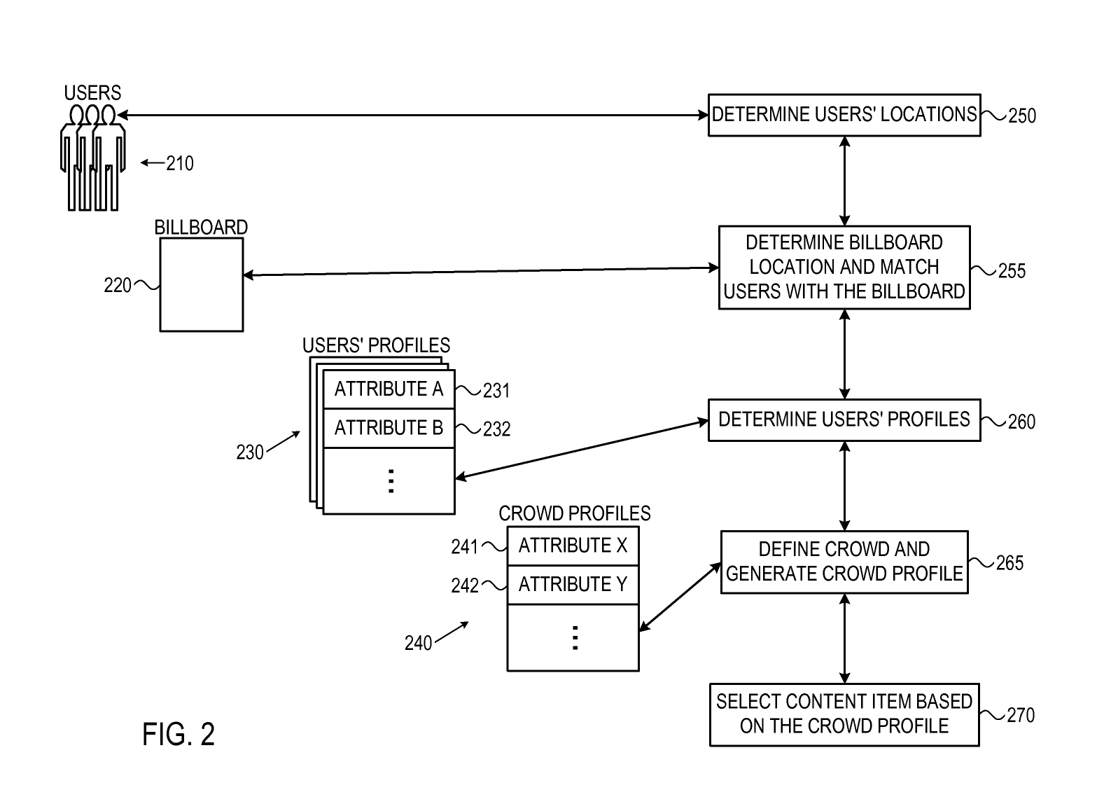

Based on attributes and parameters related to a crowd or plurality of users, crowd profiler 170 generates a crowd or group profile or description. A non-limiting example of a crowd profile is described with reference to crowd profile 240 shown in FIG. 2 and elsewhere herein. In an embodiment, after a plurality or crowd of users is associated with a billboard as described herein, the crowd is profiled, classified or categorized and an advertisement may be selected based on an attribute, profile or classification of the crowd. For example, if the majority of users in a crowd are females then a parameter in a respective crowd profile indicates that content suitable, or designed for females should be selected for display on the respective billboard.

Crowd profiler 170 may aggregate data from users and generate or produce a group profile, crowd profile, or other description by determining attributes common to users or members in a crowd. A crowd profile may include any number of parameters or entries that may be related to any relevant attribute of a crowd. For example, attributes such as age, gender, home address, income, common interests, departure points and browsed sites related to some or all users in a crowd or group may all be reflected or included in a crowd profile. For example, a common, average or median income included in a crowd profile may be determined or calculated based the income of users in the crowd, and such an attribute or statistic may be part (or all) or a crowd profile. A crowd profile may be a structure stored in memory as known in the art and/or may be stored as a file, e.g., on users database 195. Accordingly, a crowd profile may include, reflect or indicate an income or salary of a crowd (e.g. an average or median) by averaging the salary or income users in the crowd and storing this number as part or all of the profile. Any statistical or relevant methods may be used to calculate, compute or determine an attribute, value or parameter related to a crowd based on attributes, values or parameters in users' profiles.

A crowd profile may indicate a statistical distribution of age, e.g., the age of 70% of the users in the crowd is less than 16. A crowd profile may indicate the gender of the majority of the users in the crowd by using, e.g., M or F. In an embodiment, attributes, values and parameters calculated in included in a crowd profile are determined based on an interest of an advertiser. For example, any aspect or attributes of a crowd around a billboard that is of interest to an advertiser may be included. Crowd profiler 170 may receive a configuration parameter that indicates an attribute of users to be included in a crowd profile. For example, if an attribute such as ethnic group or other category related to culture or nationality is of interest to a publisher, then user profiler 160 may be configured to determine a value, rank or rate related to each user in a crowd with respect to the attribute of interest. In an embodiment, crowd profiler 170 uses values calculated by user profiler 160 to calculate or determine a value or parameter that reflects the attribute of interest with respect to the crowd. For example, a crowd profile may indicate, statistically reflect, or otherwise be used to determine the nationality (or plurality) of the majority of users in a crowd.

Crowd profiler 170 may perform data enrichment. For example, if needed, crowd profiler 170 generates data for a first user based on data of a second user in the crowd. For example, if gender information is missing for a first user, crowd profiler 170 compares browsing history of the first user to other users in the crowd, notes the gender of the matching users (users who have a similar browsing history) and determines the gender of the first user based on the gender of the majority of matching users. Similarly, if data related to interests is missing for a user it may be determined by observing a trip departure point of the user and other users in the crowd. For example, if the majority of users in a crowd are known to be interested in sports, then crowd profiler 170 may infer that the crowd is coming from a sport event, and that a user is a sports fan (e.g., even if such information is not in the user's profile).

In an embodiments, crowd profiler 170 calculates data frequencies for parameters in a crowd profile. For example, the value of a set of parameters such as age, gender, and income of each user in a crowd is added to a histogram such that frequencies of appearance of different values may be observed, frequencies may be compared etc. For example, a specific value or attribute may be selected based on the highest frequency. For example, if the frequency of males in a crowd is larger than that of females then the gender parameter of the crowd may be set to male.

A confidence, certainty or probability parameter may be associated with users' parameters and may then be used to generate a crowd profile. Rules may dictate a level of confidence or certainty that are associated with an attribute of a user. For example, if an indication that a user is a female is based only on a browsing history then a value of 25% (or 0.25) may be set for a probability parameter that is associated with the gender attribute. In another example, a probability of 100% (or 1) may be associated with a gender if the gender was provided by the user, e.g., the user provided the information to a carrier that operates network 105, and the carrier shares information with system 100. When calculating frequencies, a probability, certainty or confidence parameter value may be used. For example, if a gender of a user is set to female and is further associated with a confidence level of 25%, crowd profiler 170 adds 0.25 to the females count or frequency and 0.75 to the males count.

In an embodiment, Ad server 180 receives a crowd profile and an identification of an associated electronic billboard, e.g., from crowd profiler 170. In an embodiment, ad server 180 receives requests for advertisements from digital billboards (e.g., from electronic billboards 155 and 156). In an embodiment, a request for content received from an electronic billboard includes an identification of the requesting billboard (e.g., provided by a SIM installed in the digital billboard). In an embodiment, based on a crowd profile related to an electronic billboard that requested content, ad server 180 selects an advertisement or other content that best matches the crowd around the requesting billboard.

In an embodiment, ad server 180 associates a plurality of content items with a score based on the crowd profile and selects for presentation one of the content items based on an associated score. For example, when a group of youngsters walks near digital billboard 155, digital billboard 155 may show advertisements for fashion brand that targets youngsters, but, when business people pass by digital billboard 155, digital billboard 155 may show advertisements for luxury cars.

In an embodiment, digital billboards (e.g., digital billboards 155 and 156) include any computing and communication systems to enable them to automatically request content for presentation. In an embodiment, digital billboards are equipped with any component required in order to communicate with ad server 180 over a network as described herein. For example, a controller or computing device installed in digital billboard 156 periodically sends a request for content such that advertisements on digital billboard 156 are replaced, e.g., every two minutes. Accordingly, requests for content may be received by ad server 180 as described herein.

An identification of a billboard may be a parameter included in a SIM installed in the billboard or otherwise configured and may be known to all relevant components of system 100 For example, management 104 may store billboards identification information on configuration data 103 and may provide such information to any component in system 100 such that each digital billboard is uniquely and unambiguously identified by components of system 100. Accordingly, based on an identification of a billboard in a request received from a billboard and an identification associated with a crowd profile, ad server matches the profile with the request and selects content to be included in a response based on the profile. Accordingly, system 100 enables content presented on a billboard to be selected based on the current crowd around, or near, the billboard.

In an embodiment, ad server 180 scores content (e.g., advertisements or other presentable content objects) according to a crowd's profile. In an embodiment, content items are associated with a score based on the crowd profile and selecting for presentation one of the content items is based on an associated score. As discussed, content items may be associated with target audience or users (e.g., a publisher indicates and age, gender, direction of movement or any other attributes of a preferred audience). Parameters associated with content may be related to a crowd profile and, based on the relation on match of the content with the crowd, the content is scored. For example, content indicated as suitable for men will receive a low score with respect to a crowd profile generated for a crowd of school girls. Content associated with the highest score may be selected for presentation on the digital billboard associated with the crowd (and crowd profile). For example, for a very young crowd around digital billboard 156, an advertisement for a pension plan will be scored poorly or low by ad server 180, and, if large share of the crowd around digital billboard 156 have recently browsed parenting sites, then baby diapers advertisements may be scored high, by ad server 180, for that crowd. Any rule or criteria may be included in a selection of content by ad server 180. For example, to avoid starvation, random selection that is weighted by advertisements' scores is used.

As described herein, a system and method according to embodiments of the invention may deliver content to digital billboards or other displays, wherein the content is audience targeted based on a crowd or group that may include for example passersby, passengers and drivers near the billboard. In an embodiment, content may include “teasers” that may be any content designed to cause interest or draw attention. A teaser may be selected or generated such that it motivates people in a crowd near a digital billboard to watch the digital billboard. A teaser may appear on some portion of the billboard or on devices of users in the crowd.

For example, a teaser may be related to an origin or destination common to users in a crowd. A teaser can include a prize winner name (or nickname) of a user in the crowd. As discussed, users' data including users' profiles and the like may be available, according, a name of a user in a crown may be displayed on a billboard, e.g., in association with a prize or benefit, e.g., a digital shopping coupon. Accordingly, a billboard may interact with a crowd near the billboard. A teaser may include any content (e.g., news flash, information related to the road ahead and the like). A teaser may be selected based on the crowd's profile, e.g., using a method for selecting content to be presented on a billboard as described herein.

A crowd profile associated with a digital billboard may be dynamic and may be periodically or continuously updated. For example, as described herein, as users leave a crowd (e.g., by driving away from a billboard) or join a crowd (e.g., by walking towards a digital billboard) the crowd profile may be updated to accommodate for the changes in the crowd. A crowd profile may be updated based on an interaction with a crowd. For example, responses from users to content displayed on a billboard may be examined and used to deduce attributes or characteristics of the crowd. Content subsequently presented on the billboard may be selected based on attributes of the crowd as determined based on an interaction with the crowd. For example, if some users in a crowd respond to a teaser or advertisement by pointing a browser on their mobile or smart phones to an advertised internet site than user profile 160 may update the users real-time profile and alert crowd profile of the update. When users' profiles are updated, crowd profile 170 may update the relevant crowd profile and provide ad server 180 with an updated crowd profile. ad server 180 may select content according to a crowd profile as described herein, accordingly, content will be selected based on the updated crowd profile, and thus, content presented on a digital billboard may be selected based on an interaction with a crowd.

As discussed, a digital billboard may be mobile, e.g., installed on a vehicle. A crowd associated with a billboard may be stationary. For example, some (and in some cases, a majority of) users devices 110 may be stationary, e.g., when these devices are operated by people in restaurants and homes in a street through which a digital billboard installed on a bus is carried. In such case, the crowd at a first part of the street may be different from the crowd in a second part of the street. By profiling stationary crowds near which a digital billboard is carried or transferred, and selecting content to be presented on the billboard based on profiles of the stationary crowds, an embodiment enables the same digital billboard to provide content selected for different crowds in respective different locations. For example, in an election campaign, a billboard on a bus can promote a first candidate in a first part of town, if a target crowd defined by the first candidate is identified, and similarly promote a second candidate in a second part of town.

It will be noted a number of crowds around a digital billboard may be identified or determined and a respective number of crowd profiles may be generated as described herein. For example, based on users profiles and data provided by user profiler 160, crowd profiler 170 may determined that a crowd near a digital billboard includes a first sub-crowd (e.g., a large number of school children) and a second sub-crowd (e.g., a group of employees on a company trip). Profiles for sub-crowds in a crowd may be generated (e.g., by crowd profiler 170 as described herein) and content presented on a billboard may be selected based on a profile of a sub-crowd.

ULC 130, billboard matcher 140, user profiler 160, BLC 150, crowd profiler 170, ad server 180 and management unit 104 may each be a unit, module or other suitable entity. For example, each of these units or modules may be an executable code similar to executable code 425 described herein. In some embodiments, some or each of ULC 130, billboard matcher 140, user profiler 160, BLC 150, crowd profiler 170, ad server 180 and management unit 104 may be a component that includes elements included in device 400. For example, some or each of ULC 130, billboard matcher 140, user profiler 160, BLC 150, crowd profiler 170, ad server 180 and management unit 104 may be a device similar to device 400 wherein executable code similar to executable code 425 in the device is designed to carry out the functions of the respective module or unit. In an embodiment, some of modules or units ULC 130, billboard matcher 140, user profiler 160, BLC 150, crowd profiler 170, ad server 180 and management unit 104 may be combined into a smaller number of units or some of these units may be divided or broken into sub-units or sub-modules. For example, executable code may be rearranged as known in the art in order to differently distribute functionality of units ULC 130, billboard matcher 140, user profiler 160, BLC 150, crowd profiler 170, ad server 180 and management unit 104.

Accordingly, it will be understood that any distribution of units ULC 130, billboard matcher 140, user profiler 160, BLC 150, crowd profiler 170, ad server 180 and management unit 104 may be realized. For example, ULC 130, billboard matcher 140, user profiler 160, BLC 150, crowd profiler 170, ad server 180 and management unit 104 may all be included in a single device, e.g., as code segments similar to executable code 425 and accordingly, controller 405 may be configured to carry out methods, operations and functions described herein.

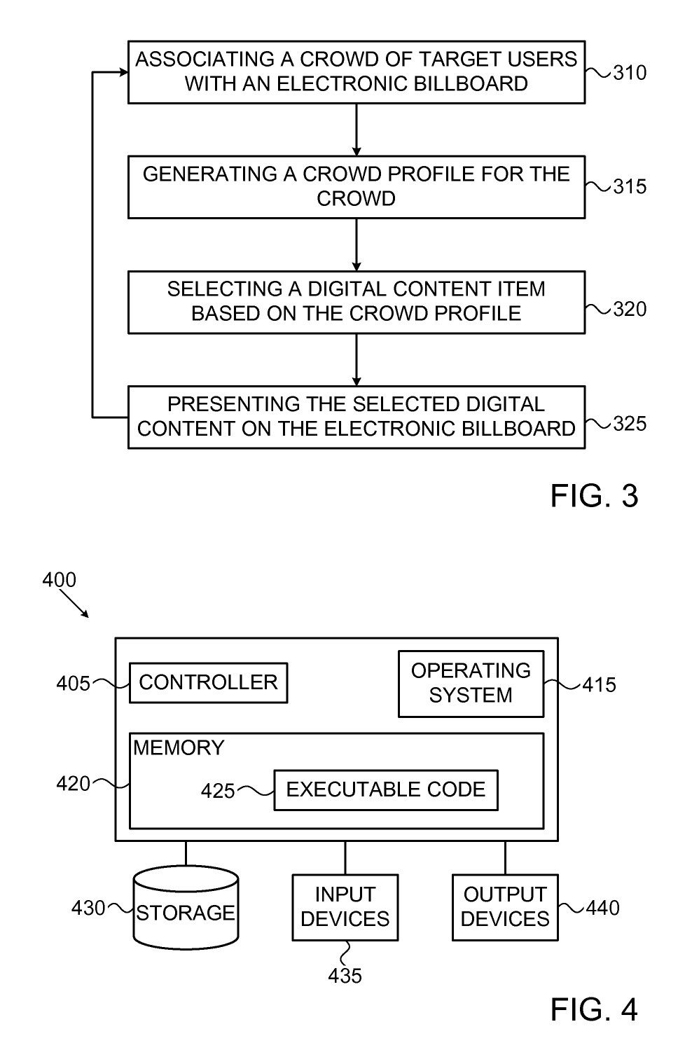

For example, in some embodiments, a plurality of devices similar to device 400 described herein may be used. In some devices, one or more processor or controller similar to controller 405 may be installed. For example, a number of computers may be used in a system wherein each of the computers executes one or more of modules ULC 130, billboard matcher 140, user profiler 160, BLC 150, crowd profiler 170, ad server 180 and management unit 104. Accordingly, one or more processors, distributed geographically or not, may carry out parts of the invention. Accordingly, a system (e.g., system 100) may comprise a memory (e.g., memory 420) and a processor (e.g., controller 405) wherein the processor is configured to associate a crowd of target users with an electronic billboard; generate a crowd profile for the crowd; select a digital content item based on the crowd profile; and present the selected digital content on the electronic billboard. A system (e.g., system 100) may comprise a memory (e.g., memory 420) and a processor (e.g., controller 405) wherein the processor is configured to carry out methods as described herein, e.g., as shown by FIG. 2 and FIG. 3 and described herein.

Reference is now made to FIG. 2 which shows a flowchart diagram and related components according to some embodiments of the present invention. Users 210 may be users associated with or operating user devices 110 as shown in FIG. 1. For example, users 210 may be users in proximity to billboard 220. Billboard 220 may be similar to electronic billboards 155 and 156 as shown in FIG. 1 and described herein. Users profiles 230 and crowd profile 240 may be any suitable component or construct, e.g., a file in a digital storage or a memory portion that includes digital data.

As shown by block 250, the location of users 210 may be determined, e.g., using GPS data generated by devices operated by the users and provided by a carrier. As described herein, other methods and systems for determining locations of users may be employed.

As shown by block 255, a location of billboard 220 may be determined and some of users included in users 210 may be associated with billboard 220. For example, based on a location of users included in users 210 and a location of billboard 220, some of the users included in users 210 may be associated with billboard 220.

As shown by block 260, users' profiles may be determined and/or generated, for example, as shown by users' profiles 230. As shown by 231 and 232, a user profile may include one or more entries that may include, describe, reflect and/or represent any attribute, parameter or value. For example, an entry or row 231 may be a gender and may, based on the gender of the relevant user, be set to a predefined value that indicates the gender of the relevant user. Entry or row 232 in a user profile may be related to an income and may be set to reflect the income of the user. Other entries or fields in a user profile may be related to an ethnic group, an age and the like. Although for the sake of clarity only two fields, entries or rows in a user profile are shown it will be understood that any number of fields and values may be included in users' profiles 230. Users' profiles 230 may be generated or updated, e.g., by user profiler 160 or they may be obtained, e.g., from users 210, from a social network or from any other applicable source.

As shown by block 265, a crowd may be defined and a profile for the crowd may be generated as shown by crowd profile 240. Generally, a crowd profile (or profile of a crowd) may be a description of a crowd or group of users. A crowd profile may characterize the group or crowd of users. Defining a crowd may include examining users associated or matched with a billboard (for example as shown by block 255 and described herein) and either including users in the crowd or group or excluding users from the crowd or group. For example, a user may initially be included in a crowd matched with a billboard (e.g., based on the user's location and/or proximity to the billboard) and subsequently, e.g., based on a criteria and an attribute of the user as indicated in the user's profile, be excluded from the crowd.

For example, a user may, at a first phase, be included in a crowd associated with a billboard based on the proximity of the user to the billboard but may, at a second phase, be excluded from the crowd, e.g., due the a direction or speed of travel. For example, even though close to a billboard, users travelling in a direction that does not enable viewing content displayed on the billboard may be excluded from a crowd associated with the billboard.

As shown by rows, fields or entries 241 and 242, a crowd profile may include a number of entries, rows or fields that may include, describe, reflect and/or represent any attribute, parameter or value related to the crowd. For example, an entry or row 241 may be a gender and may, based on the gender of the relevant users, be set to a predefined value that indicates the gender of the crowd. Since a gender of a crowd or group of people may not be a well defined attribute or value (e.g., in the case that some of the users are males and others are females) a value indicating a gender of a crowd may indicate a probability or average. For example, a value of 0.72 in field or entry 241 may indicate that 72% of the users in the crowd are females. An age of a crowd may be indicated, e.g., by averaging the ages of users in the crowd. Accordingly, a profile of a crowd or group may reflect averaged, summarized or otherwise calculated, computed or derived characteristic based on a plurality of values related to the characteristic as included in profiles of users in the crowd or group.

Any method of determining attributes or descriptions of a crowd as included in a crowd profile 240 may be used. Generally, any attribute that may be included in a user profile described herein may also be included in a crowd profile. Other data, parameter or information included in a crowd profile may be global data that may not be directly or otherwise derived from users' profiles. For example, a crowd profile may include the number of users included in the crowd, traffic information and the like.

Accordingly, a crowd profile may described or characterize a crowd in a way similar to the way a user profile describes or characterizes a user. For example, attributes, parameters or characteristics such as an income, an ethnicity, a hobby and the like may all be computed for, and included in a profile of crowd based on a plurality of users profiles. For example, a profile of crowd may be or may include a set or vector (e.g. a list of values or other data items) of values which are computed based on users profiles, e.g., using averages, medians and the like. Accordingly, a profile for or of a crowd may be generated based on attributes or parameters of users included in the crowd. For example, attributes, parameters or values indicating an age, a gender and a socioeconomic status may be included in a crowd profile and these attributes, parameters or values may be calculated or otherwise determined based on respective age, gender and socioeconomic status of users in the relevant crowd or group.

As shown by block 270, a content item may be selected based on a profile of a crowd. Accordingly, a content item may be selected for presentation by a billboard based on a profile or attribute of a crowd or group associated with the billboard.

Reference is now made to FIG. 3, a flowchart diagram illustrating a method for crowd or group based content delivery according to embodiments of the present invention. As shown by block 310, a method or flow may include associating a crowd of target users or members with an electronic billboard or other display. For example, billboard matcher 140 associates users with a billboard as described herein. Any means of associating a plurality of users with a billboard may be used. For example, references between digital representations of users and billboards (e.g., files or constructs in memory) may be used as known in the art.

As shown by block 315, the method or flow may include generating a crowd profile or summary or description for the crowd or group of target users or members. For example, crowd profiler 170 generates a crowd profile as described herein. As shown by block 320, the method or flow may include selecting a digital content item based on the crowd profile. For example, provided with a crowd profile, ad server 180 (or a module therein) matches one or more content items or objects, e.g., advertisements or campaigns, with the related crowd. In an embodiment, content such as digital content items stored on ad server 180 is examined and categorized. For example, metadata associated with a video clip or an image used for advertising a product may indicate suitable audience for the clip or image. For example, parameters or user or member characteristics such as age, gender and the like may be set in metadata associated with content to reflect, identify or indicate the target audience or users, e.g., as dictated by an advertiser. By using the same values for respective attributes in both a crowd profile and metadata in ad server 180, ad server may associate content with a crowd. For example, a crowd of boys will be matched with content indicated as directed to boys and the content will be selected, by ad server 180, for presentation.

As shown by block 325, the method or flow may include presenting or displaying the selected digital content on the electronic billboard. For example, billboards present content selected and provided by ad server 180 as described. As shown by the arrow connecting blocks 325 and 310, the flow may be iterative. As shown by the arrow connecting blocks 325 and 310, a crowd profile may be dynamically and/or continuously updated or generated. For example, a crowd profile is dynamically updated based on a proximity of a plurality of users to an electronic billboard. For example, as users walk or drive away from a billboard and other users come closer to the billboard, the crowd around the billboard changes. By dynamically and continuously updating the relevant crowd profile, system 100 can adjust the selection of content presented or display on the billboard according to the changing crowd.

Recalculating or regenerating a crowd profile may be triggered by an attrition of the crowd, e.g., loss of participants or users that moved away from a billboard. For example, if during a first period of time a crowd around a billboard is mainly young girls, and, subsequently, the crowd changes to young boys then such change may cause a recalculation or regeneration of a profile for the crowd. In an embodiment, crowd attributes or parameters (e.g., age, gender and the like) are continuously monitored and, upon detecting a significant change in the composition of the crowd, a crowd profile may be regenerated or updated. An updated crowd profile may be provided to ad server 180. Accordingly, selection of content for presentation of content based on a crowd may be dynamically performed such that the content is constantly relevant to an immediate or current crowd around a billboard.

In an embodiment, a number of sub-crowds may be identified within a crowd. For example, a first sub-crowd related to an age group may be identified and a second sub-crowd related to an ethnicity may be identified. Clearly, a user may belong to a plurality of sub-crowds. For example, based on data provided by user profiler 160, crowd profiler 170 may determine or identify a number of sub-crowds in a crowd associated with billboard 165. Selection of content presentation may be based on sub-crowds. For example, noting that the number of users belonging to, or associated with, a first sub-crowd has dropped, and the number of users associated with a second sub-crowd has increased, crowd profiler 170 may update the relevant crowd profile to reflect the changes. In an embodiment, content for two or more sub-crowds may be presented, e.g., simultaneously or sequentially. For example, a first portion of billboard 156 may be dedicated to a first sub-crowd and a second portion of billboard 156 may be dedicated to a second sub-crowd. In other embodiments, time slots for presentation of content on a billboard may be determined based on sub-crowds in a crowd.

A crowd or group may be mobile. For example, passengers in a moving train, or members of a tourist group in a bus may be identified as a moving crowd. For example, GPS data provided by a carrier or operator of a mobile network may be used to determine that a crowd of users is mobile. A crowd profile may be generated for a plurality of users moving together. For example, user profiler 160 may provide crowd profiler 170 with a list of users who are moving together, as a crowd (e.g., users on a bus as described). Crowd profiler 170 may generated a profile for the moving crowd. Content for presentation may be selected for a moving crowd. For example, a digital billboard installed inside a train may present content selected based on the crowd in the train. Similarly, a billboard placed near the train tracks may be made to present content based on the moving crowd. For example, a billboard at a train station may present a first content item when a first train (with a first moving crowd on it) is at the station and present a second content item when a second train (with a second moving crowd on it) is at the station. The content for each of the first and second crowds in the above example may be selected based on a respective first and second crowd profiles generated for the first and second moving crowds.

A destination of a crowd may be determined (e.g., based on known train or bus stations, or based on attraction sites' locations) and advertisements related to businesses at a destination may be presented. Businesses at a determined destination of a crowd may be alerted of an approaching crowd. For example, a restaurant at a train station that may be targeting customers with specific attributes (e.g., age or average income) may be informed that a suitable crowd is headed towards the restaurant and may take various actions to prepare for catering the crowd.

In some embodiments the electronic billboard is mobile, e.g., mounted on a bus as described. In an embodiment, a crowd profile generated for a mobile billboard is updated based on the location of the billboard. For example, crowd profiles for neighborhoods in a city are generated and stored (e.g., on users database 195). The billboard is then matched with a crowd profile based on the location of the billboard. For example, when a bus travels through a first neighborhood of a city, a first content element or item is selected for presentation on a billboard mounted on the bus. When subsequently the bus reaches a second neighborhood, a second crowd profile is associated with the billboard based on a second profile associated with the second neighborhood and, consequently, a second content element or item is selected for presentation. Accordingly, a crowd profile associated with a mobile electronic billboard may be dynamically updated based on a location of the electronic billboard.

Dynamically and/or continuously updating a crowd profile may be based on including new users in a crowd and/or excluding users from a crowd. For example, based on a direction of movement of a user or user device, a speed of movement of a user or user device, an origin of a trip or a destination of a trip of a user or user device, billboard matcher 140 may add the user to a crowd associated with a digital or electronic billboard, or may omit or remove the user from a crowd. For example, users travelling at a high speed may be excluded from a crowd. Since inclusion and/or exclusion of users in/from a crowd may be dynamic, the crowd profile may be periodically, dynamically or continuously calculated, based on the changing crowd. Accordingly, a crowd profile may be dynamically updated, recalculated or regenerated to reflect changes of a crowd or dynamic attributes of a crowd.

As discussed, selecting digital content item for presentation (e.g., by ad server 180) may be based on an attribute or characteristic of a crowd of target users. For example, an attribute or characteristic may be a direction of movement and a speed of movement. For example, based on a direction of movement of a majority of cars near a digital billboard a direction of movement attribute of the crowd may be determined. For example, if the majority of the cars near a billboard are moving towards a restaurant ahead then an advertisement for the restaurant may be presented on the billboard. As discussed, a crowd profile may be generated based on at least one of: an age, a gender and a socioeconomic status parameter of a majority of the users in the crowd. Other aspects that may be determined for users and further reflected in a crowd profile may be an interest in a specific field, or internet sites visited by users. As discussed, system 100 may collaborate or cooperate with any entity to obtain information related to users. For example, a carrier or an operator of a network may provide, per user, information related to internet sites browsed by the user using his or her mobile device. Social networks may be another source of (possibly anonymous) data related to users where such data may indicate fields of interest, hobbies and the like.

As described herein, generating a crowd profile may include calculating a probability value related to an attribute of a user included in the crowd and updating the crowd profile based on the probability value. In an embodiment, a digital content item is selected for presentation based on an interaction of a user with a mobile communication device. For example, a telephone number may be presented on the billboard and, if a user in a crowd associated with the billboard dials the number then the user's name, picture or other data may be displayed. A digital content item may be selected for presentation based on an interaction of a crowd with content presented on a billboard. For example, if a predefined percentage of users in a crowd responds to an advertisement for a shirt (e.g., by surfing to an advertised web site) then an advertisement for another shirt may be displayed. For example, content stored in ad server 180 is categorized as described. If a response from a large number of users for an advertisement is detected (e.g., as described), a second advertisement may be selected by noting the category of the first advertisement and selecting the second advertisement from the noted category.

A scoring of a user or a scoring of a user's attribute may be based on an interaction of the user with a mobile device. For example, as described herein, a probability value may be associated with user's attributes (e.g., the user is a male with a probability or confidence level of 0.65). Based on an interaction of a user with a communication device, e.g., surfing to a specific internet site or responding to content on a digital billboard, user profiler 160 may increase or decrease the probability or confidence value. For example, if the user responds to an advertisement related to men then the confidence level above may be raised from 0.65 to 0.89. In an embodiment, by collaborating with an operator of network 105 or otherwise, content may be presented on a user's device based on a response of the user to content presented on a billboard. For example, an advertisement including a phone number to call may be presented on a billboard. If, using her mobile phone, a user dials the number presented on the billboard, content related to the advertisement may be presented on the user's mobile phone screen. For example, if a user in a crowd calls a shop advertised on an associated billboard, advertisements for additional products in the shop may be presented on the user's device.

Content presented on a billboard may be selected based on users' actions or interactions. For example, if a predefined number or percentage of users in a crowd respond to an advertisement presented on a billboard, then the relevant crowd profile may be updated such that similar or related advertisements are presented by the billboard. For example, categories of advertisements or other content may be defined as discussed. Accordingly, if a response from a crowd (e.g., some statistical summary of the responses of users within the crowd) to an advertisement is noted as described, the profile of the crowd may be updated to indicate that a specific category of content is the preferable category for the crowd and, consequently, additional advertisements from the same category may be chosen for presentation.

Updating a crowd profile may be based on any relevant event or aspect. For example, if a group of young people included a crowd defined as described herein travels away from a billboard then the average age of the actual crowd around or near a billboard may change, in such case, the relevant crowd profile may be updated such that the average age of the crowd as indicated by the crowd profile is changed in order to reflect the change in the actual crowd.

Any method may be used in order to trigger or perform updating of a crowd profile. For example, a crowd profile for a crowd around or near a billboard may be recalculated periodically such that it is kept up to date. In another example, by tracking users location, system 100 may readily determine that a predefined portion or percentage of users who were close to a billboard are no longer near the billboard and may then recalculate a profile for the crowd near the billboard. Similarly, a predefined number or percentage of users that recently entered a region close to the billboard may trigger recalculating or updating a crowd profile.

Reference is made to FIG. 4, showing high level block diagram of an exemplary computing device according to embodiments of the present invention. Computing device 400 may include a controller 405 that may be, for example, a processor, a central processing unit processor (CPU), a chip or any suitable computing or computational device, an operating system 415, a memory 420, a storage 430, an input devices 435 and an output devices 440.

Operating system 415 may be or may include any code segment designed and/or configured to perform tasks involving coordination, scheduling, arbitration, supervising, controlling or otherwise managing operation of computing device 400, for example, scheduling execution of programs. Operating system 415 may be a commercial operating system. Memory 420 may be or may include, for example, a Random Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory 420 may be or may include a plurality of, possibly different memory units.

Executable code 425 may be any executable code, e.g., an application, a program, a process, task or script. Executable code 425 may be executed by controller 405 possibly under control of operating system 415. For example, executable code 425 may be an application or module implementing any one of ULC 130, billboard matcher 140, user profiler 160, BLC 150 and a crowd profiler 170. It will be understood that a plurality of executable code segments similar to executable code 425 may be loaded into memory 420 and executed by controller 405. Where applicable, executable code 425 may carry out operations described herein in real-time. For example, executable code 425 may associate users with a crowd and/or associate a crowd with a billboard in real-time. For example, executable code 425 may update or generate a profile for a crowd in real-time. Some embodiments may include a number of devices similar to device 400 and a respective number executable code 425 segments may carry out operations of modules or devices ULC 130, billboard matcher 140, user profiler 160, BLC 150 and crowd profiler 170. Each of units or devices such ULC 130, billboard matcher 140, user profiler 160, BLC 150 and crowd profiler 170 may include processors configured to carry out all or part of embodiments of the present invention. In some embodiments, units or devices such ULC 130, billboard matcher 140, user profiler 160, BLC 150 and crowd profiler 170, and their functionality, may be combined into units, or divided among other units. E.g., one unit may perform the functionality of more than one of these units.

Computing device 400 and executable code 425 may be configured to update, process and/or act upon information at the same rate the information, or a relevant event, are received. In some embodiments, more than one computing device 400 may be used. For example, a plurality of computing devices that include components similar to those included in computing device 400 may be connected to a network and used as a system. For example, generating and updating a crowd profile, associating a crowd with a billboard, selecting content for display on a billboard may be performed in realtime by executable code 425 when executed on one or more computing devices such computing device 400.

A system including one or more devices similar to device 400 may be deployed. For example, using any number of devices similar to device 400 that execute modules similar to modules ULC 130, billboard matcher 140, user profiler 160, BLC 150 and crowd profiler 170, a system configured or adapted to associate a crowd of target users with an electronic billboard; generate a crowd profile for the crowd; select a digital content item based on the crowd profile; and present the selected digital content on the electronic billboard. For example, user profiler 160 may be a module on a first computing device and BLC 150 may be a module on a second computing device. In other embodiments, modules ULC 130, billboard matcher 140, user profiler 160, BLC 150 and crowd profiler 170 are included in a single computing device similar to computing device 400.

Storage 430 may be or may include, for example, a hard disk drive, a floppy disk drive, a Compact Disk (CD) drive, a CD-Recordable (CD-R) drive, a universal serial bus (USB) device or other suitable removable and/or fixed storage unit. Content (e.g., crowd profiles and/or users' profiles) may be stored in storage 430 and may be loaded from storage 430 into memory 420 where it may be processed by controller 405. For example, users database 195 may be similar to storage 430.

In some embodiments, some of the components shown in FIG. 4 may be omitted. For example, memory 420 may be a non-volatile memory having the storage capacity of storage 430. Accordingly, although shown as a separate component, storage 430 may be embedded or included in memory 420.

Input devices 435 may be or may include a mouse, a keyboard, a touch screen or pad or any suitable input device. It will be recognized that any suitable number of input devices may be operatively connected to computing device 400 as shown by block 435. Output devices 440 may include one or more displays, speakers and/or any other suitable output devices. It will be recognized that any suitable number of output devices may be operatively connected to computing device 400 as shown by block 440. Any applicable input/output (I/O) devices may be connected to computing device 400 as shown by blocks 435 and 440. For example, a wired or wireless network interface card (NIC), a modem, printer or facsimile machine, a universal serial bus (USB) device or external hard drive may be included in input devices 435 and/or output devices 440.

Embodiments of the invention may include an article such as a computer or processor non-transitory readable medium, or a computer or processor non-transitory storage medium, such as for example a memory, a disk drive, or a USB flash memory, encoding, including or storing instructions, e.g., computer-executable instructions, which, when executed by a processor or controller, carry out methods disclosed herein. For example, a storage medium such as memory 420, computer-executable instructions such as executable code 425 and a controller such as controller 405.

Some embodiments may be provided in a computer program product that may include a non-transitory machine-readable medium, stored thereon instructions, which may be used to program a computer, or other programmable devices, to perform methods as disclosed herein. Embodiments of the invention may include an article such as a computer or processor non-transitory readable medium, or a computer or processor non-transitory storage medium, such as for example a memory, a disk drive, or a USB flash memory, encoding, including or storing instructions, e.g., computer-executable instructions, which when executed by a processor or controller, carry out methods disclosed herein. The storage medium may include, but is not limited to, any type of disk including floppy disks, optical disks, compact disk read-only memories (CD-ROMs), rewritable compact disk (CD-RWs), and magneto-optical disks, semiconductor devices such as read-only memories (ROMs), random access memories (RAMs), such as a dynamic RAM (DRAM), erasable programmable read-only memories (EPROMs), flash memories, electrically erasable programmable read-only memories (EEPROMs), magnetic or optical cards, or any type of media suitable for storing electronic instructions, including programmable storage devices.

A system according to embodiments of the invention may include components such as, but not limited to, a plurality of central processing units (CPU) or any other suitable multi-purpose or specific processors or controllers, a plurality of input units, a plurality of output units, a plurality of memory units, and a plurality of storage units. A system may additionally include other suitable hardware components and/or software components. In some embodiments, a system may include or may be, for example, a personal computer, a desktop computer, a mobile computer, a laptop computer, a notebook computer, a terminal, a workstation, a server computer, a Personal Digital Assistant (PDA) device, a tablet computer, a network device, or any other suitable computing device. Unless explicitly stated, the method embodiments described herein are not constrained to a particular order or sequence. Additionally, some of the described method embodiments or elements thereof can occur or be performed at the same point in time.

Unless explicitly stated, the method embodiments described herein are not constrained to a particular order or sequence. Additionally, some of the described method embodiments or elements thereof can occur or be performed at the same point in time.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

Various embodiments have been presented. Each of these embodiments may of course include features from other embodiments presented, and embodiments not specifically described may include various features described herein.

What is claimed is:

1. A method comprising:
associating a crowd of target users with an electronic billboard;
generating a crowd profile for the crowd;
selecting a digital content item based on the crowd profile; and
presenting the selected digital content on the electronic billboard.

2. The method of claim 1, comprising dynamically updating the crowd profile based on a proximity of a plurality of users to the electronic billboard.

3. The method of claim 1, wherein the electronic billboard is mobile.

4. The method of claim 3, comprising dynamically updating the crowd profile based on a location of the electronic billboard.

5. The method of claim 1, comprising including a user in the crowd of target users based on at least one of: a direction of movement, a speed of movement, an origin of a trip and a destination of a trip.

6. The method of claim 1, comprising selecting the digital content item based on an attribute of the crowd of target users, wherein the attribute is one of: a direction of movement and a speed of movement.

7. The method of claim 1, comprising generating the crowd profile based on at least one of: an age, a gender and a socioeconomic status parameter of a majority of the target users.

8. The method of claim 1, wherein generating the crowd profile includes:
calculating a probability value related to an attribute of a user included in the crowd; and
updating the crowd profile based on the probability value.

9. The method of claim 1, comprising associating a plurality of content items with a respective plurality of scores based on the crowd profile and selecting for presentation one of the content items based on an associated score.

10. The method of claim 1, comprising selecting the digital content item based on an interaction of a user with a mobile communication device, wherein the user is included in the crowd.

11. The method of claim 1, comprising generating the crowd profile based on a plurality of profiles of a respective plurality of users included in the crowd.

12. A system comprising:
a memory;
a processor configured to:
associate a crowd of target users with an electronic billboard;
generate a crowd profile for the crowd;
select a digital content item based on the crowd profile; and
provide the selected digital content to the electronic billboard.

13. The system of claim 12, wherein the processor is configured to dynamically update the crowd profile based on a proximity of a plurality of users to the electronic billboard.

14. The system of claim 12, wherein the electronic billboard is mobile.

15. The system of claim 14, wherein the processor is configured to dynamically update the crowd profile based on a location of the electronic billboard.

16. The system of claim 12, wherein the processor is configured to include a user in the crowd of target users based on at least one of: a direction of movement, a speed of movement, an origin of a trip and a destination of a trip.

17. The system of claim 12, wherein the processor is configured to select the digital content item based on an attribute of the crowd of target users, wherein the attribute is one of: a direction of movement and a speed of movement.

18. The system of claim 12, wherein the processor is configured to generate the crowd profile based on at least one of: an age, a gender and a socioeconomic status parameter of a majority of the target users.

19. A method comprising:
for a crowd of users associated with a display, generating a description based on characteristics of the users; and
displaying a content item based on the description.

20. The method of claim 19, comprising updating the description based on a proximity of a plurality of users to the display.
